(19) United States
(12) Patent Application Publication
(10) Pub. No.: US 2014/0232994 A1
(43) Pub. Date: Aug. 21, 2014

(54) Low power laser CRT and projection system based on parallel flow electron gun

(71) Applicants: Zhongping Xia, Shanghai (CN); Jian Zhao, Shanghai (CN); Yuan Yan, Shanghai (CN); Xueyuan Zhang, Shanghai (CN); Weijie Zhong, Shanghai (CN)

(72) Inventors: Zhongping Xia, Shanghai (CN); Jian Zhao, Shanghai (CN); Yuan Yan, Shanghai (CN); Xueyuan Zhang, Shanghai (CN); Weijie Zhong, Shanghai (CN)

(21) Appl. No.: 13/521,222

(22) PCT Filed: May 29, 2012
(86) PCT No.: PCT/CN12/76195

§ 371 Date: Jul. 10, 2012

(30) Foreign Application Priority Data
Oct. 31, 2011 (CN) 201110338790.0

(51) Int. Cl. H01J 29/48; G03B 21/20

(52) U.S. Cl. CPC H01J 29/481; G03B 21/2033
USPC 353/33; 313/441

(57) ABSTRACT

The present invention relates to electronic technology field, and more particularly to CRT and projection system. A low power laser CRT based on parallel flow electron gun comprises a vacuum tube, a laser panel provided at one end of the vacuum tube and an electron gun provided at the opposing end. The electron gun adopts a parallel flow electron gun, wherein the parallel flow electron gun comprises a negative electrode, a G1 electrode and a control electrode, wherein the control electrode is connected to an electron beam current control system. The electron gun of the present invention adopts parallel flow electron gun to emit electron beam, so that the laser panel has even current density distribution so as to average the power consumption of laser panel to reduce the energy that is converted to heat.

### BACKGROUND OF THE PRESENT INVENTION

1. Field of Invention

The present invention relates to electronic technology field, and more particularly to CRT and projection system.

2. Description of Related Arts

With the emerging of the miniaturized and portable electronic equipment, the existing projection equipments usually adopt handheld and low power consumption projection equipment. The light source best suitable for this type of projection equipment is laser light source or light emitting diode. The laser light source is widely recognized as high efficient light source with low power consumption and high brightness.

The projection system converts light emitted from light source to picture image by utilizing optical modulator. At present, this type of optical modulator usually uses projective/reflective liquid crystal display (LCD), liquid crystal on silicon (LCoS), and digital micro-mirror device (DMD) in Digital Light Procession (DLP) technology. Light source with three primary colors is needed in order to show picture image.

Cathode Ray Tube (CRT) is a display that uses cathode ray tube, consisting of glass cover, electron gun, deflection yoke and stress panel. The traditional CRT technology is being widely applied to TV and computer screen and also being applied to projection optical mechanical structures, but the efficiency is not very high and the brightness is limited.

The laser light source can also be excitated vian electron beam in CRT by hitting the electron beam produced by electron gun of CRT onto the laser panel, which has advantages of decorrelation and high brightness. However, the electron beam excitation system of common light source uses cross electron gun, which will produce Gaussian-like current density distribution on image plane. The cross electron gun has many drawbacks in terms of light emitting mechanism, such as large proportion of energy is converted to heat, and the power consumption in the lightening area is not even, which will shorten the average life span of the chip.

### SUMMARY OF THE PRESENT INVENTION

An object of the present invention is to provide a low power laser CRT based on parallel flow electron gun to solve the above-mentioned problems.

Another object of the present invention is to provide a projection system to solve the above-mentioned problems.

In order to accomplish the objects, the present invention provides:

A low power laser CRT based on parallel flow electron gun, comprising a vacuum tube having a first end and an opposing second end, a laser panel provided at the first end of the vacuum tube and an electron gun provided at the second end, characterized in that the electron gun adopts a parallel flow electron gun, wherein the parallel flow electron gun comprises a negative electrode, a G1 electrode and a control electrode, wherein the control electrode is connected to an electron beam current control system.

The electron gun of the present invention can emit high speed electron beam with enough intensity to laser cavity of the laser panel, which can produce laser effect so as to produce laser. The laser cavity can adopt laser chip. Through the control of electron beam current control system, control the electron beam current via control electrode to so as to change the current intensity. The voltage of control electrode determines the brightness of the outside screen in front of laser panel. The electron beam emitted by the parallel flow electron gun is parallel flow electron beam, so the parallel flow electron gun has higher brightness and better decorrelation.

When the parallel flow electron gun is applied to common imaging CRT display, the parallel flow is easy to be damaged, the scanning range is small, and the suitable laser chip has to be small, so that the parallel flow electron gun can hardly applied to display. However, the parallel flow electron gun of the present invention is applied to excite the laser light source so as to avoid the drawbacks of the parallel flow electron gun.

The parallel flow electron gun of the present invention produces parallel flow electron beam, which has even current density distribution on the laser chip, so that comparing with the cross electron gun, the present invention improves the energy efficiency and decrease the damage to the laser chip by using the parallel flow electron gun. The main tracks of electrons of parallel flow electron beam do not cross, and the space charge effect is small, so that smaller beam spot can be formed so as to improve the energy density input to the laser chip. Therefore, the present invention takes advantages of the parallel flow electron gun.

The present invention can eliminate laser speckle, and is more controllable. The light source illustrated above can also use rear projection and front projection light source. Furthermore, the electron gun of the present invention adopts parallel flow electron gun to emit electron beam, so that the laser panel has even current density distribution so as to average the power consumption of laser panel to reduce the energy that is converted to heat.

The negative electrode and the laser panel are applied with positive voltage respectively, and a double-driver modulation system is further included, which is connected with the negative electrode and G1 electrode respectively. The double-driver modulation system can modulates the response control signal of the negative electrode and G1 electrode, so as to adjust the voltage of the negative electrode and G1 electrode to realize high resolution.

Negative voltage can also be applied to the negative electrode, positive voltage is applied to the laser panel, the negative voltage power source and positive voltage power source are connected in series, and the connection point is grounded. The negative electrode is applied with high negative voltage power source of 0˜−20 kv, and the laser panel is applied with high positive voltage power source of 0˜+20 kv. Due to the above design, the high voltage passing through the laser CRT can be divided in the present invention, the negative potential is suitable for the negative electrode, and positive potential is suitable for the positive electrode. The total potential on the laser panel is close to the potential difference of the positive potential and negative potential.

The electron beam current control system is connected to the negative electrode and G1 electrode 132 respectively. The electron beam current control system controls the negative electrode and other electrodes of the electron gun to produce required electron beam. The electron beam scans the laser panel to produce laser with required output intensity. The electron beam current control system adjusts and controls current vian electron gun, so as to control the output intensity of laser.

The present invention does not need to rapidly modulate electron beam current, only need to load a constant voltage on the negative electrode to produce an electron beam current, which will hit the laser panel to produce laser light source, and do not need to apply expensive modulation electrode on the negative electrode. Therefore, the electron beam control system and electron gun are simple and cheap. The electron beam current control system can solely adjust the voltage of control current on the negative electrode or other electrodes. The present invention adjusts the electrode voltage of the electron gun via the electron beam current control system to produce required constant output per unit.

A focusing-deflection system is provided in front of the parallel flow electron gun, and the laser panel is provided in front of the focusing-deflection system.

The focusing-deflection system includes a focusing coil provided in front of the electron gun and a deflection yoke provided in front of the focusing coil. The laser panel is provided in front of the deflection yoke. In order to maintain the parallel flow of the parallel flow electron beam, the deflection angle of the deflection yoke must be small, and must be in the linear deflection area of the deflection yoke. The focusing coil and deflection yoke form a complex focusing-deflection lens integrating focusing and deflection function in front of parallel flow electron gun, in order to overcome the drawback that the parallel flow of the parallel flow electron beam is easily damaged.

Control the current of the deflection yoke to let the parallel electron beam to scan the laser chip line by line, so that the lasers emitted by the whole laser chip area mix to eliminate spatial coherence.

The vacuum tube includes an infundibulate glass cover. A laser panel is provided on a wide angle end of the glass cover, and a parallel flow electron gun provided on the other end of the glass cover. The vacuum tube can also adopt a long-tubular vacuum tube. The structure design of the vacuum tube and parallel flow electron gun can be altered according the real application.

The laser panel includes at least two laser cavities, that are at least two laser chips, and at least two laser cavities are overlapped in parallel to form the laser panel. The laser cavity includes a gain medium layer and two reflective layers, wherein the two reflective layers are provided at two sides of the gain medium layer respectively.

The two reflective layers are partial reflective layer and complete reflective layer respectively, wherein the partial reflective layer is provided in front of the gain medium layer and the complete reflective layer is provided on the back of the gain medium layer. Therefore, the photon can be excited for many times in the laser cavity.

The laser light source produced in the present invention has three different colors paralleled side by side; the laser panel includes at least two laser cavities; at least two laser cavities produce one color of the three primary colors, and at least two laser cavities are overlapped in parallel.

The laser panel includes at least three rows of laser cavities, wherein the laser cavities in one row produce same color, which is different from the color of neighboring rows. When the present invention is used for laser light source, the produced laser light source has three rows with different colors respectively. When the present invention is used for projection system, only one laser CRT is needed for light source, and an optical prism group is used to synthesize the laser light source of different colors in three rows to three-color synthesized light, which can greatly save the number of laser CRT so as to save the cost of projection system.

The laser light source produced in the present invention has mixed three different colors; the laser panel includes at least two laser cavities; at least two laser cavities produce one color of the three primary colors, and at least two laser cavities are overlapped in parallel.

The laser panel includes at least two rows of laser cavities. The color of laser emitted from one laser cavity has different color of the laser emitted from the neighboring laser cavity. When the present invention is used for laser light source, the produced laser light source is three-color synthesized light that is synthesized by different colors. When the present invention is used for projection system, only one laser CRT is needed for light source, so that the light sources of three different colors is saved. Via a complex structure of using optical prism group to synthesize one synthesized light beam, the number of laser CRT is greatly saved, and the structure of the projection system is simpler and the cost is lower.

The present invention further includes a panel cooling system, which includes a manifold pipe, a heat exchange system and a coolant, wherein the coolant is provided in the manifold pipe, the heat exchange system connects with the entrance and exit of the manifold pipe, and the manifold pipe includes a peripheral manifold pipe provided outside of the laser panel. The coolant flows through the entire periphery of the laser panel via manifold pipe. The laser panel is cooled and the temperature of coolant rises. The coolant with raised temperature exits the manifold pipe, and enters into the heat exchange system to get cooled and ready for another cycle.

The manifold pipe further includes a panel manifold provided on the laser panel between two neighboring laser cavities.

The panel manifold is provided between the neighboring two rows of laser cavities, and the panel manifold crosses vertically and horizontally on the laser panel. Providing manifold pipe on the laser panel can cool the laser panel better and more even.

The coolant adopts insulated and transparent coolant, so that the laser panel cooling system is insulated with high voltage and other electrical isolation system can be omitted. The coolant can also adopt medium coolant, such as Fluorinert manufactured by 3M, and also can adopt perfluoro liquid or other nonconductive liquid.

The laser panel cooling system includes at least two manifold pipes, communicated with each other, and at least one of the two manifold pipes is connected to the heat exchange system 22, so that the laser panel 12 is better and more evenly cooled.

The projection system includes a light source system, an optical prism group and a projection optical system. The light source system includes three laser CRTs that are used to produce laser. The colors of laser light source produced by three laser CRTs are three primary colors respectively and the laser produced by three laser CRTs are formed to one three-color synthesized light beam via an optical prism group 4.

Using laser CRT light source as the light source of projection system in the present invention can eliminate laser speckle and is more controllable.

The optical prism group can adopt an X prism. The lasers produced by three laser CRTs can form three-color synthesized light through X prism.

The projection optical system further includes a beam shaper, which is a compound eye lens having lens arranged in matrix on the surface thereof. The beam shaper is provided between the projection light source and objective lens, so that the light beam emitted from the light source system diverges, and is converted to the shape of effective area of optical modulator.

The projection optical system further includes three optical modulators (SLM), which are provided on the light path between the laser CRT and optical prism group.

The projection system includes a light source system, an optical prism group and a projection optical system. The light source system includes one laser CRT that are used to produce laser of three primary colors. The three primary colors of laser form one three-color synthesized light beam via an optical prism group.

The laser panel of laser CTR includes at least two laser cavities; at least two laser cavities produce one color of the three primary colors, and at least two laser cavities 121 are overlapped in parallel.

The laser panel includes at least three rows of laser cavities, wherein the laser cavities in one row produce same color, which is different from the color of neighboring rows.

The present invention uses laser CRT light source as the light source for projection system, and the produced laser light source has three rows with different colors respectively. Therefore, the present invention only needs one laser CRT as light source, and uses an optical prism group to synthesize the laser light source of different colors in three rows to three-color synthesized light, which can greatly save the number of laser CRT so as to save the cost of projection system.

The projection system includes a light source system and a projection optical system. The light source system includes a laser CRT for producing laser; The laser panel of laser CTR includes at least two laser cavities; at least two laser cavities produce one color of the three primary colors, and at least two laser cavities 121 are overlapped in parallel.

The laser panel includes at least two rows of laser cavities. The color of laser emitted from one laser cavity has different color of the laser emitted from the neighboring laser cavity.

The present invention uses laser CRT light source as the light source for projection system, and the produced laser light source is three-color synthesized light mixed by the different colors. When the present invention is used for projection system, only one laser CRT is needed for light source, so that the light sources of three different colors is saved. Via a complex structure of using optical prism group to synthesize one synthesized light beam, the number of laser CRT is greatly saved, and the structure of the projection system is simpler and the cost is lower.

The present invention further includes an optical prism group, which is provided in front of the exit surface of the laser CRT. The laser emitted from the laser CRT of the present invention has formed into a three-color synthesized light. In order to further mix the three primary colors. An optical prism group provided in front of the laser CRT can mix colors better and make the colors of the projection system more even and stable.

The present invention further includes a panel cooling system, which includes a manifold pipe, a heat exchange system and a coolant, wherein the coolant is provided in the manifold pipe, the heat exchange system connects with the entrance and exit of the manifold pipe, and the manifold pipe includes a peripheral manifold pipe provided outside of the laser panel. The coolant flows through the entire periphery of the laser panel via manifold pipe. The laser panel is cooled and the temperature of coolant rises. The coolant with raised temperature exits the manifold pipe, and enters into the heat exchange system to get cooled and ready for another cycle.

The manifold pipe further includes a panel manifold provided on the laser panel between two neighboring laser cavities.

The panel manifold is provided between the neighboring two rows of laser cavities, and the panel manifold crosses vertically and horizontally on the laser panel. Providing manifold pipe on the laser panel can cool the laser panel better and more even.

The low poser laser CRT based on the parallel flow electron gun further includes a blower. There is a closed cavity provided between the laser panel and the optical modulator. The entrance and exit of the blower are all provided in the closed cavity. The blower drives the air flow in the closed cavity to take away the heat of the laser panel and the optical modulator. The air is only internally circulated, so that the outside dust can not be brought to the laser panel and optical modulator.

An optical prism group is provided between the laser panel and optical modulator, and a closed cavity is defined between the laser panel and the optical prism group. The entrance and exit of the blower are all provided in the closed cavity. The blower drives the air flow in the closed cavity to take away the heat of the laser panel.

The blower is provided outside the closed cavity, and communicated with the entrance and exit via air duct, so as to avoid taking up the space in the closed cavity.

The closed cavity is surrounded by a metal casing, which can be used to dissipate heat. The metal casing includes a radiating fin extending into the closed cavity provided on the inner side of the metal casing and outer radiating fin extending into the outside air on the outer side of the metal casing. The low poser laser CRT based on the parallel flow electron gun further includes a fan for accelerating the outside air flowing through the outside of the metal casing to improve the heat dissipating effect.

Beneficial effect: due to the employment of the above technique, the laser light source of the present invention can eliminate laser speckle and is more controllable. The electron gun adopts parallel flow electron gun to emit electron beam, so that the laser panel has even current density distribution so as to average the power consumption of laser panel to reduce the energy that is converted to heat.

These and other objectives, features, and advantages of the present invention will become apparent from the following detailed description, the accompanying drawings, and the appended claims.

### BRIEF DESCRIPTION OF THE DRAWINGS

FIG. 1 is a schematic view of laser CRT of the present invention.

FIG. 2 is another schematic view of laser CRT of the present invention.

FIG. 3 is a schematic view of laser panel of the present invention.

FIG. 4 is another schematic view of laser panel of the present invention.

FIG. 5 is a schematic view of projection system using three laser CRTs.

FIG. 6 is another schematic view of projection system using three laser CRTs.

FIG. 7 is a schematic view of projection system using one laser CRT.

FIG. 8 is another schematic view of projection system using one laser CRT.

### DETAILED DESCRIPTION OF THE PREFERRED EMBODIMENT

For better understanding of the technique, features and objectives and effect of the present invention, the present invention is further illustrated as below with accompanying figures.

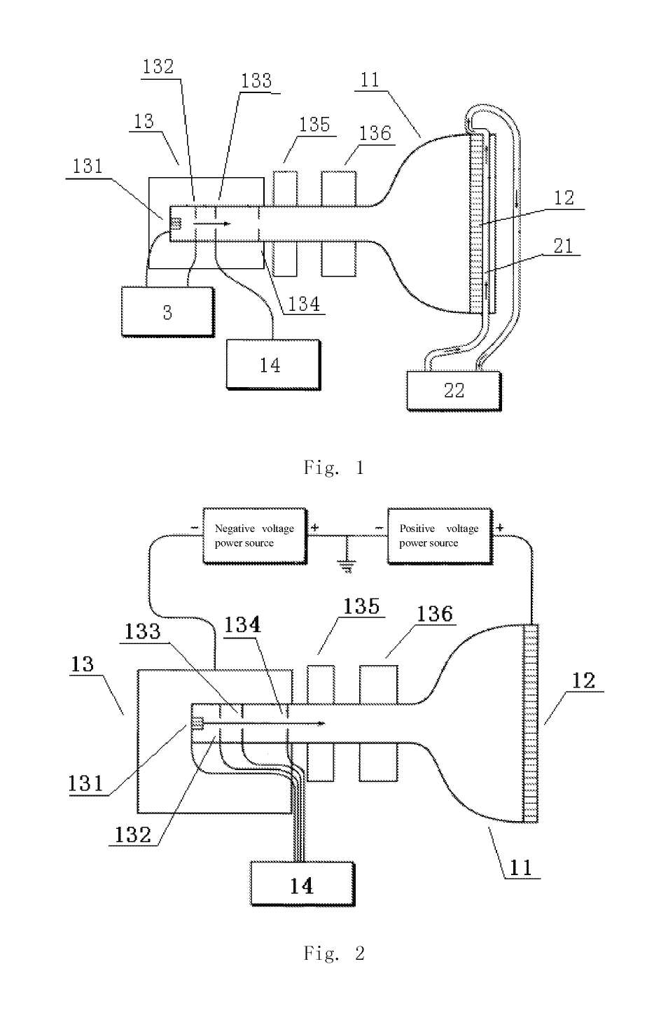

Referring to FIG. 1 and FIG. 2, the low power laser CRT based on parallel flow electron gun comprises a vacuum tube, which includes an infundibulate glass cover 11, a laser panel 12 provided on a wide angle end of the glass cover 11, and an electron gun provided on the other end of the glass cover 11. The electron gun adopts parallel flow electron gun 13. The structure design of the vacuum tube and parallel flow electron gun 13 can be altered according the real application. The vacuum tube can also adopt a long-tubular vacuum tube.

The parallel flow electron gun 13 comprises a negative electrode 131, a G1 electrode 132 and a control electrode 133, wherein the control electrode 133 is connected to an electron beam current control system 14. The electron gun of the present invention can emit high speed electron beam with enough intensity to laser cavity of the laser panel 12, which can produce laser effect so as to produce laser. The laser cavity adopts laser chip.

The electron beam emitted by the parallel flow electron gun 13 is parallel flow electron beam, so the parallel flow electron gun has higher brightness and better decorrelation. When the parallel flow electron gun is applied to common imaging CRT display, the parallel flow is easy to be damaged, the scanning range is small, and the suitable laser chip has to be small, so that the parallel flow electron gun can hardly applied to display. However, the parallel flow electron gun 13 of the present invention is applied to excite the laser light source so as to avoid the drawbacks of the parallel flow electron gun 13.

The parallel flow electron gun 13 of the present invention produces parallel flow electron beam, which has even current density distribution on the laser panel 12, so that comparing with the cross electron gun, the present invention improves the energy efficiency and decrease the damage to the laser chip by using the parallel flow electron gun. The main tracks of electrons of parallel flow electron beam do not cross, and the space charge effect is small, so that smaller beam spot can be formed so as to improve the energy density input to the laser panel 12. Therefore, the present invention takes advantages of the parallel flow electron gun.

Through the control of electron beam current control system 14, control the electron beam current via control electrode 133 to so as to change the current intensity. The voltage of control electrode 133 determines the brightness of the outside screen 6 in front of laser panel 12. The present invention can eliminate laser speckle, and is more controllable. The light source illustrated above can also use rear projection and front projection light source. Furthermore, the electron gun of the present invention adopts parallel flow electron gun to emit electron beam, so that the laser panel 12 has even current density distribution so as to average the power consumption of laser panel to reduce the energy that is converted to heat.

Referring to FIG. 1, positive voltage can be respectively applied to the negative electrode 131 and laser panel 12. The present invention further includes a double-driver modulation system 3 connected with the negative electrode and G1 electrode 132 respectively. The double-driver modulation system 3 can modulates the response control signal of the negative electrode 131 and G1 electrode 132, so as to adjust the voltage of the negative electrode 131 and G1 electrode 132 to realize high resolution.

Referring to FIG. 2, negative voltage can also be applied to the negative electrode 131, positive voltage is applied to the laser panel 12, the negative voltage power source and positive voltage power source are connected in series, and the connection point is grounded. Preferably, the negative electrode 131 is applied with high negative voltage power source of 0˜−20 kv, and the laser panel 12 is applied with high positive voltage power source of 0˜+20 kv. The high voltage passing through the laser CRT can be divided in the present invention, so that the negative potential is suitable for the negative electrode 131, positive potential is suitable for the positive electrode. The total potential on the laser panel 12 is close to the potential difference of the positive potential and negative potential. The electron beam current control system 14 is connected to the negative electrode 131 and G1 electrode 132 respectively. The electron beam current control system 14 controls the negative electrode 131 and other electrodes of the electron gun to produce required electron beam. The electron beam scans the laser panel 12 to produce laser with required output intensity. The electron beam current control system 14 adjusts and controls current vian electron gun, so as to control the output intensity of laser. The present invention does not need to rapidly modulate electron beam current, only need to load a constant voltage on the negative electrode 131 to produce an electron beam current, which will hit the laser panel 12 to produce laser light source, and do not need to apply expensive modulation electrode on the negative electrode 131. Therefore, the electron beam control system and electron gun are simple and cheap. The electron beam current control system 14 can solely adjust the voltage of control current on the negative electrode 131 or other electrodes. The present invention adjusts the electrode voltage of the electron gun via the electron beam current control system 14 to produce required constant output per unit.

Referring to FIG. 1 and FIG. 2, a focusing-deflection system is provided in front of the parallel flow electron gun 13, and the laser panel 12 is provided in front of the focusing-deflection system. The focusing-deflection system includes a focusing coil 135 provided in front of the electron gun and a deflection yoke 136 provided in front of the focusing coil 135. The laser panel 12 is provided in front of the deflection yoke 136. In order to maintain the parallel flow of the electron beam, the deflection angle of the deflection yoke 136 must be small, and must be in the linear deflection area of the deflection yoke 136.

The focusing coil 135 and deflection yoke 136 form a complex focusing-deflection lens integrating focusing and deflection function in front of parallel flow electron gun 13, in order to overcome the drawback that the parallel flow of the parallel flow electron beam is easily damaged. Control the current of the deflection yoke 136 to let the parallel electron beam to scan the chip, that is laser panel 12, line by line, so that the lasers emitted by the whole chip area mix to eliminate spatial coherence.

The deflection yoke 136 can also be provided in the inner ring, and the focusing coil 135 is provide outside, so that the deflection yoke 136 and focusing coil 135 are combined to improve the performance.

The electron gun further includes a G3 electrode 134, wherein the control electrode 133 serves as G2 electrode, the G1 electrode 132 is provided between the negative electrode 131 and the G2 electrode and the G1 electrode 132 is applied with negative voltage. The G3 electrode 134 is provided between the G2 electrode and the focusing coil 135.

The laser panel 12 includes at least two laser cavities, and at least two laser cavities are overlapped in parallel to form the laser panel 12. The laser cavity includes a gain medium layer and two reflective layers, wherein the two reflective layers are provided at two sides of the gain medium layer respectively. The two reflective layers are partial reflective layer and complete reflective layer respectively, wherein the partial reflective layer is provided in front of the gain medium layer and the complete reflective layer is provided on the back of the gain medium layer. Therefore, the photon can be excited for many times in the laser cavity.

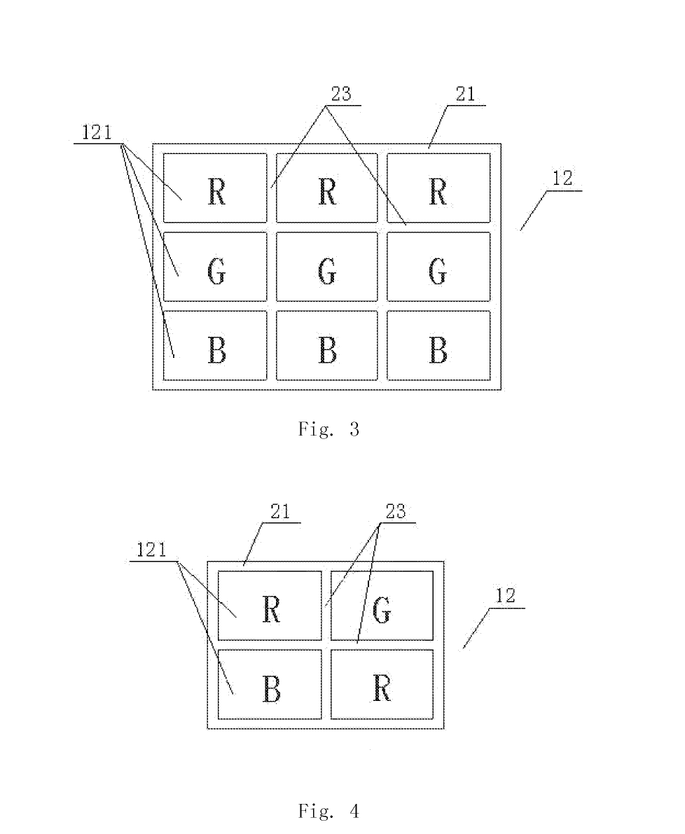

Referring to FIG. 3, the laser light source produced in the present invention has three different colors paralleled side by side; the laser panel 12 includes at least two laser cavities 121; at least two laser cavities 121 produce one color of the three primary colors, and at least two laser cavities 121 are overlapped in parallel. The laser panel 12 includes at least three rows of laser cavities 121, wherein the laser cavities in one row produce same color, which is different from the color of neighboring rows. When the present invention is used for laser light source, the produced laser light source has three rows with different colors respectively. When the present invention is used for projection system, only one laser CRT is needed for light source, and an optical prism group is used to synthesize the laser light source of different colors in three rows to three-color synthesized light, which can greatly save the number of laser CRT so as to save the cost of projection system.

Referring to FIG. 4, the laser light source produced in the present invention is a laser light source that mixes three primary colors; the laser panel 12 includes at least two laser cavities 121; at least two laser cavities 121 produce one color of the three primary colors, and at least two laser cavities 121 are overlapped in parallel. The laser panel 12 includes at least two rows of laser cavities 121. The color of laser emitted from one laser cavity has different color of the laser emitted from the neighboring laser cavity. When the present invention is used for laser light source, the produced laser light source is three-color synthesized light that is synthesized by different colors. When the present invention is used for projection system, only one laser CRT is needed for light source, so that the light sources of three different colors is saved. Via a complex structure of using optical prism group to synthesize one synthesized light beam, the number of laser CRT is greatly saved, and the structure of the projection system is simpler and the cost is lower.

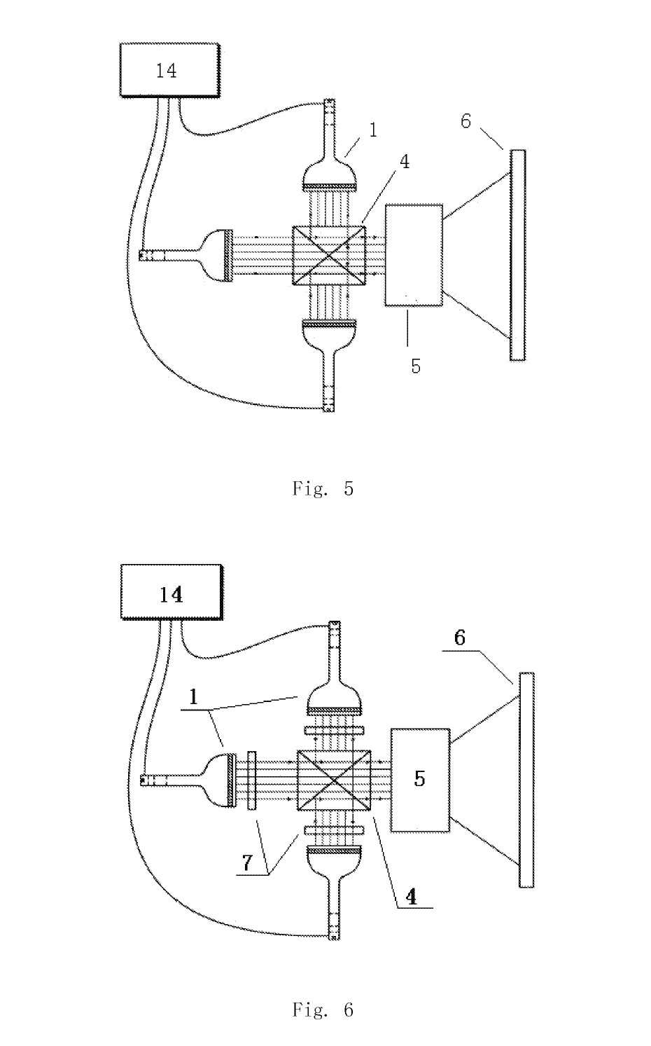

Referring to FIGS. 5 and 6, the projection system includes a light source system, an optical prism group 4 and a projection optical system 5. A screen 6 is provided in front of the projection optical system. The light source system includes three laser CRT1s that are used to produce laser. The colors of laser light source produced by three laser CRT1s are three primary colors respectively and the laser produced by three laser CRT1s are formed to one three-color synthesized light beam via an optical prism group. Using laser CRT1 light source as the light source of projection system can eliminate laser speckle and is more controllable.

The optical prism group 4 can adopt an X prism. The lasers produced by three laser CRT1s can form three-color synthesized light through X prism. The projection optical system 5 further includes a beam shaper, which is a compound eye lens having lens arranged in matrix on the surface thereof. The beam shaper is provided between the projection light source and objective lens, so that the light beam emitted from the light source system diverges, and is converted to the shape of effective area of optical modulator.

Referring to FIG. 6, The projection optical system 5 further includes three optical modulators 7, which are provided on the light path between the laser CRT1 and optical prism group 4. The optical modulator 7 may adopt Liquid Crystal on Silicon (LCOS). The optical modulator 7 may also adopt Grating Light Valve (GLV) or Digital Micro-mirror Device (DMD), so as to reduce the volume and lower the power consumption.

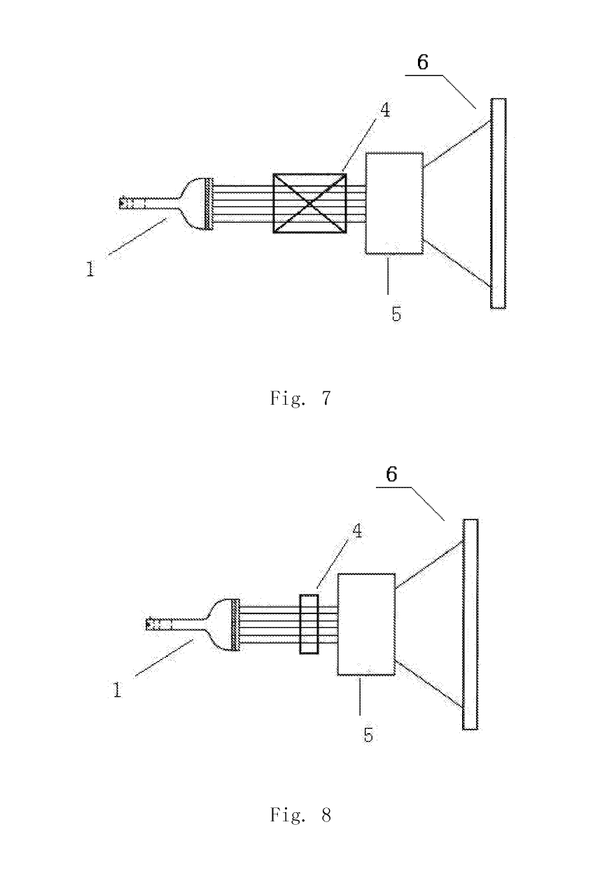

Referring to FIG. 7, the projection system includes a light source system, an optical prism group 4 and a projection optical system 5. The light source system includes a laser CRT1 that can produce lasers of three primary colors, which form a three-color synthesized light beam via an optical prism group 4.

Referring to FIG. 3, the laser panel 12 includes at least two laser cavities 121; at least two laser cavities 121 produce one color of the three primary colors, and at least two laser cavities 121 are overlapped in parallel. The laser panel 12 includes at least three rows of laser cavities 121, wherein the laser cavities in one row produce same color, which is different from the color of neighboring rows. The present invention uses laser CRT1 light source as the light source for projection system, and the produced laser light source has three rows with different colors respectively. Therefore, the present invention only needs one laser CRT1 as light source, and uses an optical prism group to synthesize the laser light source of different colors in three rows to three-color synthesized light, which can greatly save the number of laser CRT so as to save the cost of projection system.

Referring to FIG. 8, the projection system includes a light source system and a projection optical system 5. The light source system includes a laser CRT1 that can produce laser.

Referring to FIG. 4, the laser panel 12 includes at least two laser cavities 121; at least two laser cavities 121 produce one color of the three primary colors, and at least two laser cavities 121 are overlapped in parallel; the color of laser emitted from one laser cavity has different color of the laser emitted from the neighboring laser cavity. The present invention uses laser CRT light source as the light source for projection system, and the produced laser light source is three-color synthesized light mixed by the different colors. When the present invention is used for projection system, only one laser CRT is needed for light source, so that the light sources of three different colors is saved. Via a complex structure of using optical prism group 4 to synthesize one synthesized light beam, the number of laser CRT is greatly saved, and the structure of the projection system is simpler and the cost is lower.

The present invention further includes an optical prism group 4, which is provided in front of the exit surface of the laser CRT. The laser emitted from the laser CRT of the present invention has formed into a three-color synthesized light. In order to further mix the three primary colors, an optical prism group 4 provided in front of the laser CRT can mix colors better and make the colors of the projection system more even and stable.

Referring to FIG. 1, the present invention further includes a panel cooling system, which includes a manifold pipe, a heat exchange system 22 and a coolant, wherein the coolant is provided in the manifold pipe, the heat exchange system 22 connects with the entrance and exit of the manifold pipe, and the manifold pipe includes a peripheral manifold pipe 21 provided outside of the stress panel. The coolant flows through the entire periphery of the laser panel 12 via manifold pipe. The laser panel 12 is cooled and the temperature of coolant rises. The coolant with raised temperature exits the manifold pipe, and enters into the heat exchange system 22 to get cooled and ready for another cycle.

Referring to FIGS. 3 and 4, the manifold pipe further includes a panel manifold 23 provided on the laser panel 12 between two neighboring laser cavities 121. The panel manifold 23 is provided between the neighboring two rows of laser cavities 121, and the panel manifold 23 crosses vertically and horizontally on the laser panel 12. Providing manifold pipe on the laser panel 12 can cool the laser panel 12 better and more even.

The manifold pipe includes at least two pipes, communicated with each other, and at least one of the two pipes is connected to the heat exchange system 22, so that the laser panel 12 is better and more evenly cooled. Preferably, the peripheral manifold pipe 21 and panel manifold 23 are communicated with each other. The coolant adopts insulated and transparent coolant, so that the panel cooling system is insulated with high voltage and other electrical isolation system can be omitted. The coolant can also adopt medium coolant, such as Fluorinert manufactured by 3M, and also can adopt perfluoro liquid or other nonconductive liquid.

The low poser laser CRT based on the parallel flow electron gun further includes a blower. There is a closed cavity provided between the laser panel 12 and the optical modulator 7. The entrance and exit of the blower are all provided in the closed cavity. The blower drives the air flow in the closed cavity to take away the heat of the laser panel 12 and the optical modulator 7. The air is only internally circulated, so that the outside dust can not be brought to the laser panel 12 and optical modulator 7. The blower is provided outside the closed cavity, and communicated with the entrance and exit via air duct, so as to avoid taking up the space in the closed cavity.

An optical prism group is provided between the laser panel 12 and optical modulator 7, and a closed cavity is defined between the laser panel 12 and the optical prism group 4. The entrance and exit of the blower are all provided in the closed cavity. The blower drives the air flow in the closed cavity to take away the heat of the laser panel 12.

The closed cavity is surrounded by a metal casing, which can be used to dissipate heat. The metal casing includes a radiating fin extending into the closed cavity provided on the inner side of the metal casing and outer radiating fin extending into the outside air on the outer side of the metal casing. The low poser laser CRT based on the parallel flow electron gun further includes a fan for accelerating the outside air flowing through the outside of the metal casing to improve the heat dissipating effect.

### Embodiment I

Referring to FIG. 5, three laser CRT1s provide red, green and blue laser light source respectively. Each laser CRT1 includes an electron beam current control system 14 to control the control electrode 133, and couples and shapes the laser light source produced by the laser CRT1 via a suitable X prism and projects it to the screen 6 via an optical projection system 5 to form a full color image. In order to achieve the color balance of the ideal projection image, the control electrode 133 of each laser CRT1 can solely be controlled via the electron beam current control system 14. The adjustment can be done manually. For example, let user solely control each laser CRT1. Or the electron beam current control system 14 can automatically adjusts the expected color balance via automatic feedback of a sensor.

### Embodiment II

Referring to FIG. 6, three laser CRT1s provide red, green and blue laser light source respectively. Three laser CRT1s module the laser light via the optical modulator 7, couples and shapes the laser light via a suitable X prism, and projects it to the screen 6 via an optical projection system 5 to form a full color image. In order to achieve the color balance of the ideal projection image, each laser CRT1 can solely be adjusted via the electron beam current control system 14. The adjustment can be done manually. For example, let user solely control each laser CRT1. Or the electron beam current control system 14 can automatically adjusts the expected color balance via automatic feedback of a sensor.

### Embodiment III

Referring to FIG. 7, the projection system only adopts one laser CRT1 that can produce three parallel beams of laser light source, wherein the three beams of laser light source are three primary colors respectively. Three beams of laser light source forms one beam of three-color synthesized light. This structure effectively saves the number of laser CRT, and reduces the space and cost of the projection system. When the laser CRT1 as shown in FIG. 7 is adopted, referring to FIG. 3, the laser panel 12 includes three rows of laser cavities 121, wherein the first row of laser cavity 121 uses red laser cavity of the three primary colors, marked with R; the second row of laser cavity 121 uses green laser cavity of the three primary colors, marked with G; the third row of laser cavity 121 uses blue laser cavity of the three primary colors, marked with B. The panel manifold 23 is provided between the neighboring two rows of laser cavities 121; the peripheral manifold pipe 21 is provided outside of the laser panel 12; the peripheral manifold pipe 21 and panel manifold 23 are communicated with each other, and connected with the heat exchanged system 22. The laser CRT with this structure can emit three rows laser light source of different colors respectively.

### Embodiment IV

Referring to FIG. 8, the projection system only adopts one laser CRT1. The difference between embodiment IV and embodiment III is that one laser CRT can produce synthesized light beam, so that optical prisms are omitted. When the laser CRT1 as shown in FIG. 8 is adopted, referring to FIG. 4, the laser panel 12 includes at least two rows of laser cavities 121, wherein the first row of laser cavity 121 uses red laser cavity and green laser cavity of the three primary colors, marked with R and G; the second row of laser cavity 121 uses green laser cavity and blue laser cavity of the three primary colors, marked with G and B. The panel manifold 23 is provided between the neighboring two rows of laser cavities 121; the peripheral manifold pipe 21 is provided outside of the laser panel 12; the peripheral manifold pipe 21 and panel manifold 23 are communicated with each other, and connected with the heat exchanged system 22. The laser CRT with this structure can emit three-color synthesized light.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A low power laser CRT based on parallel flow electron gun, comprising: a vacuum tube having a first end and an opposing second end, a laser panel provided at the first end of the vacuum tube and an electron gun provided at the second end, characterized in that the electron gun adopts a parallel flow electron gun, wherein the parallel flow electron gun comprises a negative electrode, a G1 electrode and a control electrode, wherein the control electrode is connected to a electron beam current control system.

2. The low power laser CRT based on parallel flow electron gun, as recited in claim 1, wherein the negative electrode and the laser panel are applied with positive voltage respectively, and further comprising a double-driver modulation system which is connected with the negative electrode and the G1 electrode respectively.

3. The low power laser CRT based on parallel flow electron gun, as recited in claim 1, wherein a negative voltage power source is applied to the negative electrode and a positive voltage power source is applied to the laser panel, wherein the negative voltage power source and positive voltage power source are connected in series forming a connection point, and the connection point is grounded.

4. The low power laser CRT based on parallel flow electron gun, as recited in claim 3, wherein the negative electrode is applied with negative voltage of 0˜−20 kv, and the laser panel is applied with positive voltage of 0˜+20 kv.

5. The low power laser CRT based on parallel flow electron gun, as recited in claim 3, wherein the electron beam current control system is connected to the negative electrode and the G1 electrode respectively.

6. The low power laser CRT based on parallel flow electron gun, as recited in any one of claims 1-5, wherein a focusing-deflection system is provided in front of the parallel flow electron gun, and the laser panel is provided in front of the focusing-deflection system, wherein the focusing-deflection system comprises a focusing coil provided in front of the electron gun and a deflection yoke provided in front of the focusing coil; the laser panel is provided in front of the deflection yoke.

7. The low power laser CRT based on parallel flow electron gun, as recited in claim 6, wherein the vacuum tube comprises a infundibulate glass cover, wherein the laser panel is provided on a wide angle end of the glass cover, and the parallel flow electron gun is provided on an opposite end of the glass cover.

8. The low power laser CRT based on parallel flow electron gun, as recited in claim 6, wherein the vacuum tube is a tubular vacuum tube, wherein the laser panel is provided in front of the vacuum tube, and the parallel flow electron gun is provided on back of the vacuum tube.

9. The low power laser CRT based on parallel flow electron gun, as recited in any one of claims 1-5, wherein the laser panel comprises at least two laser cavities, which are at least two laser chips, and at least two laser cavities are overlapped in parallel; the laser cavity comprises a gain medium layer and two reflective layers, wherein the two reflective layers are provided at two sides of the gain medium layer respectively.

10. The low power laser CRT based on parallel flow electron gun, as recited in claim 9, wherein the two reflective layers are partial reflective layer and complete reflective layer respectively, wherein the partial reflective layer is provided in front of the gain medium layer and the complete reflective layer is provided on the back of the gain medium layer.

11. The low power laser CRT based on parallel flow electron gun, as recited in claim 9, wherein at least two laser cavities produce one color of three primary colors, and at least two laser cavities are overlapped in parallel, wherein the laser panel comprises at least three rows of laser cavities, wherein the laser cavities in one row produce same color, which is different from the color of neighboring rows.

12. The low power laser CRT based on parallel flow electron gun, as recited in claim 9, wherein at least two laser cavities produce one color of three primary colors, and at least two laser cavities are overlapped in parallel, wherein the laser panel comprises at least two rows of laser cavities, wherein the color of laser emitted from one laser cavity has different color of the laser emitted from the neighboring laser cavity.

13. The low power laser CRT based on parallel flow electron gun, as recited in claim 9, further comprising a panel cooling system which comprises a manifold pipe comprising a peripheral manifold pipe provided outside of the laser panel, a heat exchange system connecting with entrance and exit of the manifold pipe, and a coolant provided in the manifold pipe, wherein the manifold pipe further comprises a panel manifold provided on the laser panel between two neighboring laser cavities, wherein the panel manifold is provided between the neighboring two rows of laser cavities, and the panel manifold crosses vertically and horizontally on the laser panel.

14. The low power laser CRT based on parallel flow electron gun, as recited in claim 9, further comprising a blower and an optical modulator, wherein there is a closed cavity provided between the laser panel and the optical modulator; the entrance and exit of the blower are all provided in the closed cavity, so that the blower drives the air flow in the closed cavity to take away the heat of the laser panel and the optical modulator.

15. The low power laser CRT based on parallel flow electron gun, as recited in claim 14, wherein the blower is provided outside the closed cavity, and communicated with the entrance and exit via air duct, so as to avoid taking up space in the closed cavity.

16. The low power laser CRT based on parallel flow electron gun, as recited in claim 13, further comprising a blower and an optical modulator, wherein an optical prism group is provided between the laser panel and the optical modulator, and a closed cavity is defined between the laser panel and the optical prism group, wherein the entrance and exit of the blower are all provided in the closed cavity, so that the blower drives the air flow in the closed cavity to take away the heat of the laser panel, wherein the blower is provided outside the closed cavity, and communicated with the entrance and exit via air duct.

17. The low power laser CRT based on parallel flow electron gun, as recited in claim 14, wherein the closed cavity is surrounded by a metal casing, which can be used to dissipate heat.

18. The low power laser CRT based on parallel flow electron gun, as recited in claim 17, wherein the metal casing comprises a radiating fin extending into the closed cavity provided on an inner side of the metal casing and an outer radiating fin extending into outside air on an outer side of the metal casing; further comprising a fan for accelerating outside air flowing through outside of the metal casing.

19. A projection system, comprising an light source system, an optical prism group and a projection optical system, wherein the light source system comprises three laser CRTs as recited in claim 1, wherein the colors of laser light source produced by three laser CRTs are three primary colors respectively and the laser produced by three laser CRTs are formed to one three-color synthesized light beam via the optical prism group.

20. A projection system, comprising a light source system and a projection optical system, wherein the light source system comprises a laser CRT as recited in claim 1, wherein the laser panel of the laser CTR comprises at least two laser cavities which produce one color of three primary colors, and at least two laser cavities are overlapped in parallel, wherein the laser panel comprises at least two rows of laser cavities, wherein the color of laser emitted from one laser cavity has different color of the laser emitted from the neighboring laser cavity.
